(19) United States
(12) Patent Application Publication
(10) Pub. No.: US 2025/0070360 A1
(43) Pub. Date: Feb. 27, 2025

(54) BATTERY REPLACEMENT SYSTEM AND BATTERY REPLACEMENT APPARATUS

(71) Applicant: Isuzu Motors Limited, Yokohama-shi, Kanagawa (JP)

(72) Inventor: Muneyuki OSAWA, Fujisawa-shi (JP)

(73) Assignee: Isuzu Motors Limited, Yokohama-shi, Kanagawa (JP)

(21) Appl. No.: 18/810,578

(22) Filed: Aug. 21, 2024

(30) Foreign Application Priority Data
Aug. 22, 2023 (JP) 2023-134543

(51) Int. Cl. H01M 50/249

(52) U.S. Cl. CPC H01M 50/249; H01M 2220/20

(57) ABSTRACT

A battery replacement apparatus of the present disclosure includes: an arm that holds a battery; and an arm moving section that moves the arm. The arm moving section includes: a first lifting portion for moving the arm at least in a vertical direction within an apparatus main body of the battery replacement apparatus; and a second lifting portion for moving the arm in a vertical direction outside the apparatus main body.

### CROSS REFERENCE TO RELATED APPLICATIONS

This application claims the benefit of priority of Japanese Patent Application No. 2023-134543, filed on Aug. 22, 2023, the contents of which are incorporated by reference as if fully set forth herein in their entirety.

### TECHNICAL FIELD

The present disclosure relates to a battery replacement system and a battery replacement apparatus.

### BACKGROUND ART

Electric vehicles have been rapidly spreading recently. There are two main methods for charging batteries of the electric vehicles.

The first method is to charge electricity directly from a commercial power source or the like to a battery at a charging station. The second method is to replace a battery with a charged battery at a battery replacement station (sometimes called quick change station).

The second method is suitable for, for example, a large vehicle (e.g., truck, dump truck, and bus) that takes a long time of charging with the first method due to a large battery capacity. Such a battery replacement station is described in Patent Literature (hereinafter referred to as “PTL”) 1, PTL 2, and the like.

### CITATION LIST

### Patent Literature

### PTL 1

Japanese Unexamined Patent Application Publication (Translation of PCT Application) No. 2021-508432

### PTL 2

Japanese Unexamined Patent Application Publication (Translation of PCT Application) No. 2022-547117

### SUMMARY OF INVENTION

### Technical Problem

The present disclosure provides a battery replacement system and a battery replacement apparatus each capable of removing and attaching a battery quickly and reliably compared with conventional configurations.

### Solution to Problem

A battery replacement system according to one aspect of the present disclosure is a battery replacement system for replacing a battery mounted on a vehicle, the battery replacement system including:

a bracket that is installed on the vehicle and holds the battery; and

a battery replacement apparatus, in which the battery replacement apparatus includes:
an arm that holds the battery; and
an arm moving section that moves the arm, and in which the arm moving section includes:
a first lifting portion for moving the arm at least in a vertical direction within an apparatus main body of the battery replacement apparatus; and
a second lifting portion for moving the arm in a vertical direction outside the apparatus main body of the battery replacement apparatus.

A battery replacement apparatus according to one aspect of the present disclosure is a battery replacement apparatus for replacing a battery mounted on a vehicle, the battery replacement apparatus including:

an arm that holds the battery; and

an arm moving section that moves the arm,

in which the arm moving section includes:

a first lifting portion for moving the arm at least in a vertical direction within an apparatus main body of the battery replacement apparatus; and

a second lifting portion for moving the arm in a vertical direction outside the apparatus main body.

### Advantageous Effects of Invention

According to the present disclosure, it is possible to achieve a battery replacement system and a battery replacement apparatus each capable of removing and attaching a battery quickly and reliably compared with a conventional configuration.

### BRIEF DESCRIPTION OF DRAWINGS

FIG. 1 is a schematic perspective view provided for describing an overall configuration of a battery replacement system according to an embodiment;

FIG. 2 is a perspective view of an overall configuration of a battery replacement apparatus;

FIG. 3 is a perspective view of a detailed configuration of a mechanism installed in an interior space of a turning frame;

FIG. 4 is a perspective view of the position of each actuator;

FIG. 5 is a diagram provided for describing an operation according to the embodiment;

FIG. 6 is another diagram provided for describing the operation according to the embodiment;

FIG. 7 is still another diagram provided for describing the operation according to the embodiment;

FIG. 8 is still another diagram provided for describing the operation according to the embodiment;

FIG. 9 is still another diagram provided for describing the operation according to the embodiment;

FIG. 10 is still another diagram provided for describing the operation according to the embodiment;

FIG. 11 is yet another diagram provided for describing the operation according to the embodiment;

FIG. 12 is a side view of a positional relation in a vertical direction of a battery mounted on a vehicle and the battery replacement apparatus; and

FIG. 13 is a schematic perspective view of installation of a container according to another embodiment.

### DESCRIPTION OF EMBODIMENTS

Hereinafter, an embodiment of the present disclosure will be described with reference to the drawings.

### 1. Overall Configuration of Battery Replacement System

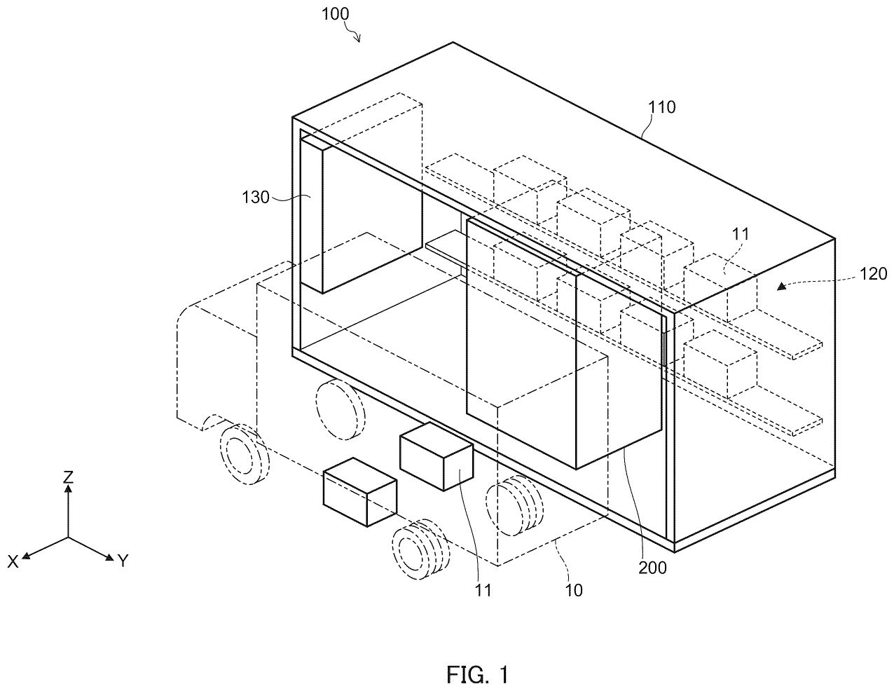

FIG. 1 is a schematic perspective view provided for describing an overall configuration of a battery replacement system according to an embodiment. Battery replacement system 100 replaces battery 11 of vehicle 10. Vehicle 10 is, for example, a large vehicle such as a truck or a bus. Vehicle 10 is stopped in front of battery replacement system 100.

In the following description, it is assumed that a direction approaching vehicle 10 from battery replacement system 100 is X direction, a rear direction of a front/rear direction of the vehicle is Y direction, and a vertical direction is Z direction. Note that, in the following, a case will be described where battery replacement system 100 is placed only on one side of vehicle 10, but battery replacement system 100 may be placed on both sides of vehicle 10 and battery 11 may be replaced from the both sides.

Battery replacement system 100 includes container 110 transportable by a trailer, housing section 120 that houses battery 11, control unit 130, and battery replacement apparatus 200. Housing section 120, control unit 130, and battery replacement apparatus 200 are installed in container 110. Note that control unit 130 may be placed outside container 130, without limitation to the inside of container 130.

Housing section 120 is a shelf capable of housing therein a plurality of batteries 11 in the Y direction and the Z direction. Housing section 120 is provided with charging equipment (not illustrated). Batteries 11 housed in housing section 120 are charged by the charging equipment.

Battery replacement apparatus 200 removes battery 11, which is mounted on vehicle 10, from vehicle 10 and then houses the battery in housing section 120, and also removes charged battery 11, which is housed in housing section 120, from housing section 120 and then attaches the battery to vehicle 10.

Control unit 130 controls battery replacement apparatus 200 and the charging equipment.

When battery replacement apparatus 200 is used, container 110 is lowered from a cargo bed of the trailer to the ground with a crane, and a door facing vehicle 10 of container 110 is opened.

### 2. Configuration of Battery Replacement Apparatus

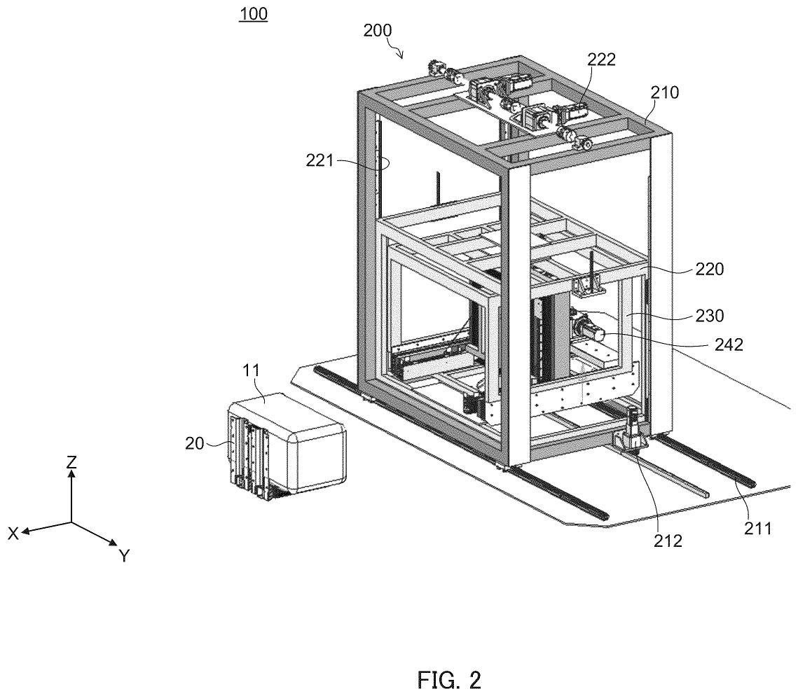

FIG. 2 is a perspective view of an overall configuration of battery replacement apparatus 200.

Battery replacement apparatus 200 includes traveling frame 210, traveling rail 211, first lifting frame 220, and turning frame 230. Traveling frame 210 moves along traveling rail 211 in the +Y direction by a driving force of drive actuator 212.

First lifting frame 220 is installed in an interior space covered with traveling frame 210 and moves along lifting rail 221 in the +Z direction by a driving force of first-lift actuator 222.

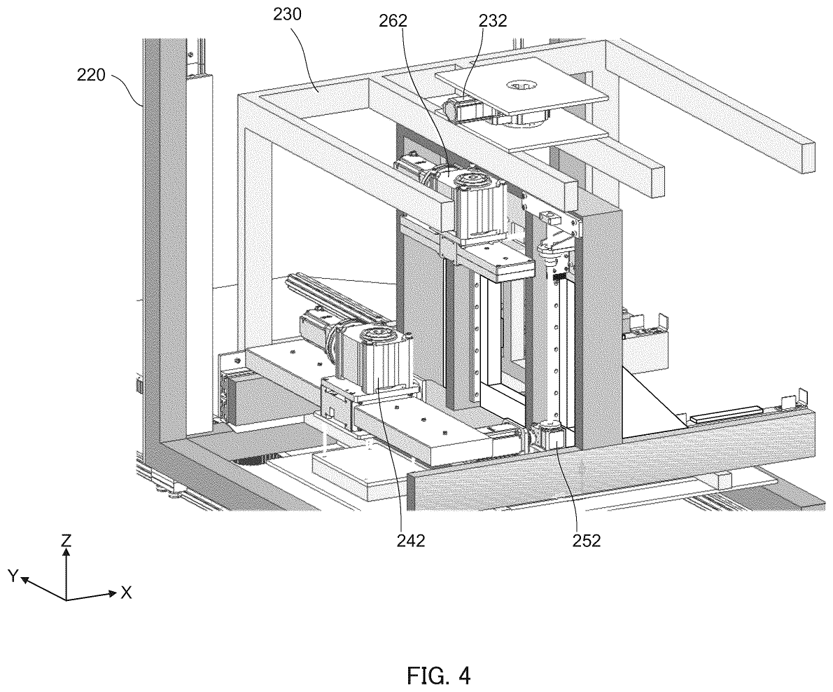

Turning frame 230 is installed in an interior space covered with first lifting frame 220 and turns (rotates) with a rotation axis in the Z direction by a driving force of turn actuator 232 to be described later (FIG. 4).

Incidentally, battery 11 is held by battery bracket 20 while being mounted on vehicle 10. Note that battery bracket 20, which is fixed to vehicle 10, has a function of positioning and holding battery 11 in a predetermined battery mounting position and has a function of guiding battery 11 to a pulling position to be described later.

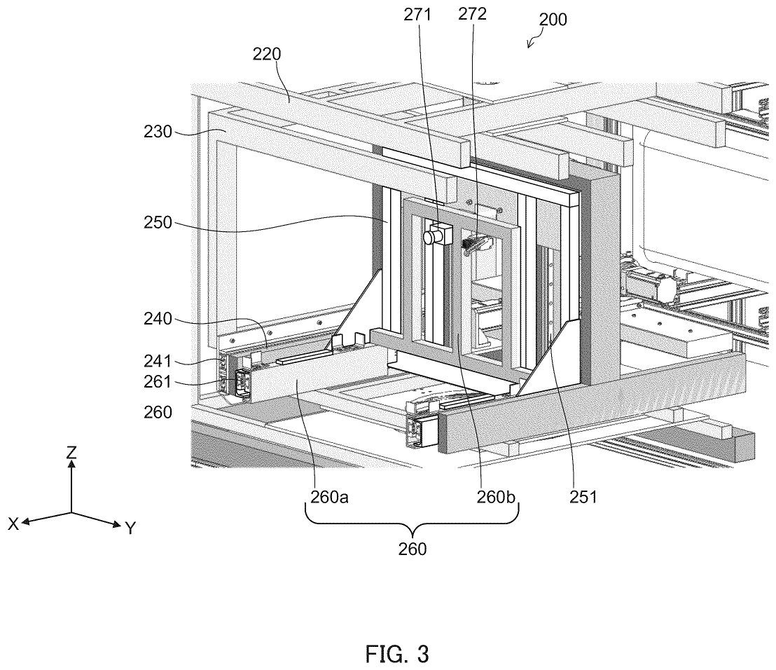

FIG. 3 is a perspective view of a detailed configuration of a mechanism installed in an interior space of turning frame 230. FIG. 4 is a perspective view of the position of each actuator.

In the interior space of turning frame 230, first slide frame 240, second lifting frame 250, and battery-holding arm 260 are installed. Battery-holding arm 260 may be referred to as a second slide frame.

First slide frame 240 is slidably supported by slide rail 241 fixed to turning frame 230 and moves in the ±X direction by a driving force of first-slide actuator 242.

Second lifting frame 250 is liftably supported by guide rail 251 fixed to first slide frame 240 and moves in the ±Z direction by a driving force of second-lift actuator 252.

Battery-holding arm 260 is slidably supported by slide rail 261 fixed to second lifting frame 250 and moves in the ±X direction by a driving force of battery-holding-arm actuator 262.

Battery-holding arm 260 includes placement portion 260a on which battery 11 is placed and pushout portion 260b that pushes battery 11 toward vehicle 10. Battery-holding arm 260 has a substantially L-shaped outline, as viewed from the ±Y direction, in which a placement surface of placement portion 260a and a push-out surface of pushout portion 260b are perpendicular to each other.

Pushout portion 260b is provided with battery-position detecting camera 271 and battery-detection limit switch 272. An image obtained with battery-position detecting camera 271 is transmitted to control unit 130, and control unit 130 controls, based on this image, positions in the Y and Z directions of members that move battery-holding arm 260. This allows battery-holding arm 260 to accurately access the position where battery 11 is mounted, and a position in the X direction is controlled by means of battery-detection limit switch 272. In addition, control unit 130 attaches battery 11 for replacement to vehicle 10, based on the position of battery 11 at the time of removal from vehicle 10.

Battery-detection limit switch 272 includes a lever that is pushed down by a side surface of battery 11 when battery 11 is placed on a predetermined position of battery-holding arm 260. Battery-detection limit switch 272 detects, based on a state of this lever, whether battery 11 is placed on the predetermined position of battery-holding arm 260 and transmits a detection result to control unit 130. Control unit 130 switches, based on this detection result, operations of the respective members that move battery-holding arm 260.

### 3. Operation of Battery Replacement Apparatus

Next, an operation of battery replacement apparatus 200 will be described.

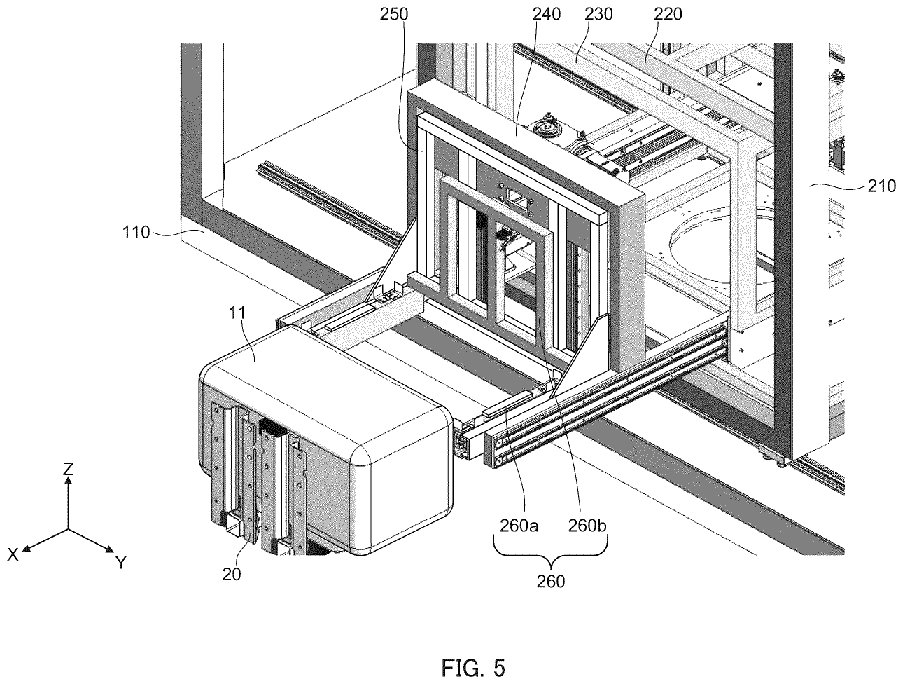

First, as illustrated in FIG. 5, battery replacement apparatus 200 moves traveling frame 210 in the Y direction so that battery-holding arm 260 is positioned in front of battery 11.

Battery replacement apparatus 200 also lowers first lifting frame 220 to the lowermost position. Note that a position of first lifting frame 220 need not necessarily be the lowermost position, as long as the frame is moved to a vertical position corresponding to the position of battery 11.

Battery replacement apparatus 200 then moves first slide frame 240 in a direction of battery 11 (+X direction). This movement in the direction of battery 11 is performed until at least the position of second lifting frame 250 in the X direction protrudes from outside of container 110.

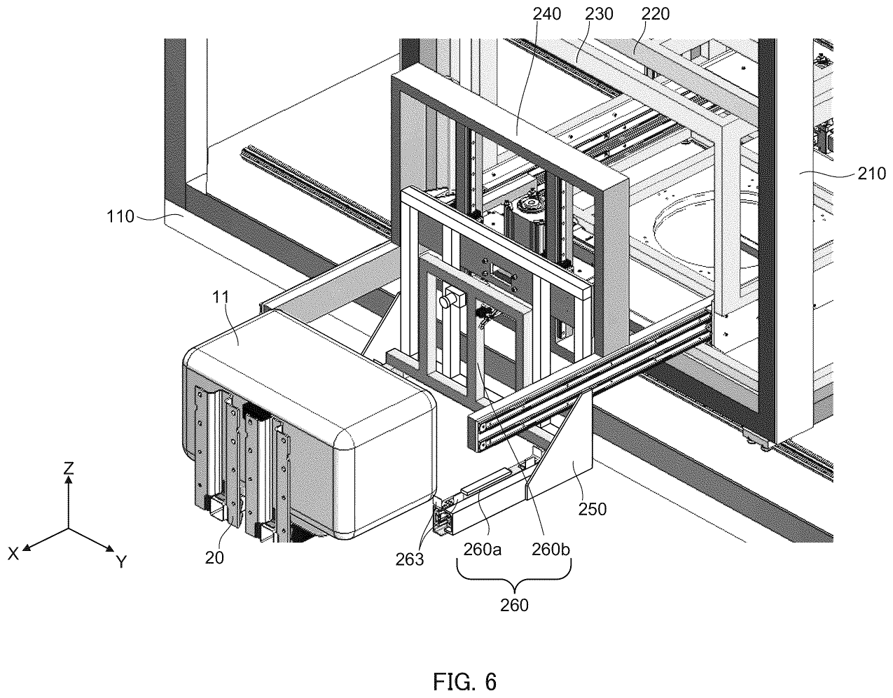

Battery replacement apparatus 200 then lowers second lifting frame 250, as illustrated in FIG. 6. The lowering of second lifting frame 250 is performed until at least the portion of battery-holding arm 260 holding battery 11 is positioned downward a lower surface of battery 11.

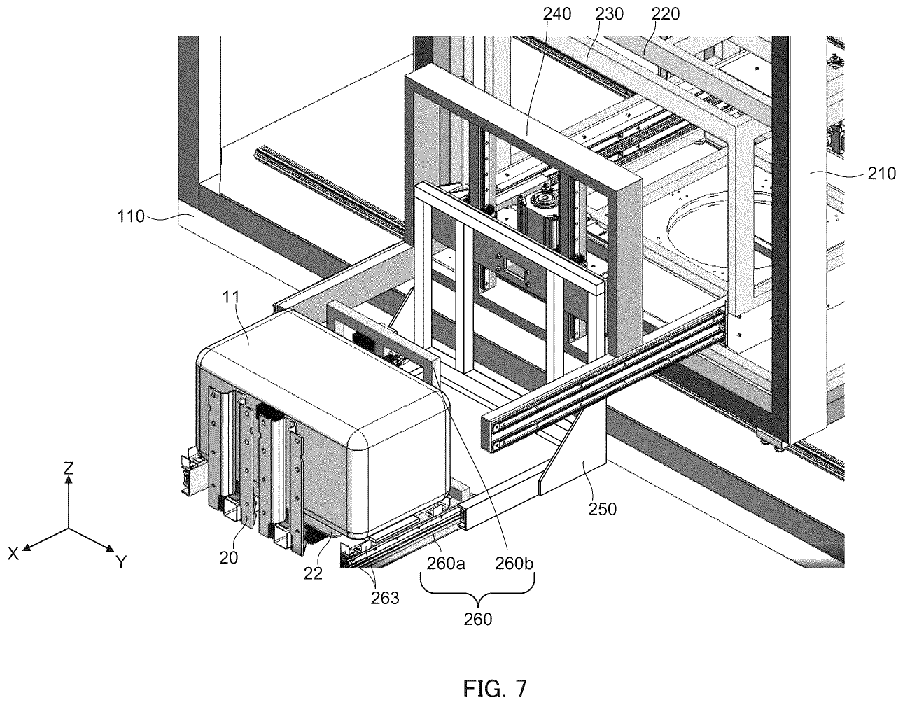

Next, as illustrated in FIG. 7, battery replacement apparatus 200 moves battery-holding arm 260 in the direction of battery 11 (+X direction).

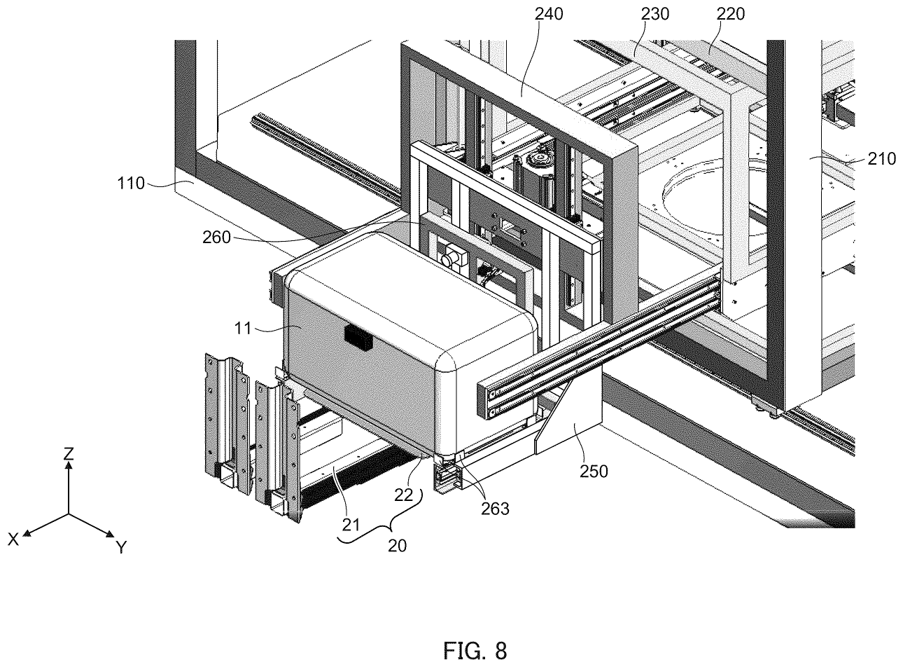

Then, as illustrated in FIG. 8, battery replacement apparatus 200 moves battery-holding arm 260 to the −X direction while holding battery 11 by battery-holding arm 260. Here, prior to the state illustrated in FIG. 8, battery replacement apparatus 200 first slightly raises second lifting frame 250 from the state illustrated in FIG. 7. The raised position at this time is a position where battery 11 is locked to locking claws 263 formed in battery-holding arm 260 and cannot be lifted by battery-holding arm 260. Thus, when battery 11 is locked to locking claws 263, causing battery-holding arm 260 to move in the −X direction results in the state illustrated in FIG. 8.

The state illustrated in FIG. 8 is a state in which battery 11 is pulled out to the side of vehicle 10. In other words, FIG. 8 illustrates the state in which no vehicle body is present above battery 11.

Note that locking claws 263 are formed at positions respectively corresponding to four corners of battery 11. Locking claws 263 are provided so as to regulate the positions of battery 11 in the X direction and the Y direction at the four corners, and are composed of a total of eight claws. Locking claws 263 prevent battery 11 from shifting in the X direction and/or Y direction in a state where the battery is held by battery-holding arm 260.

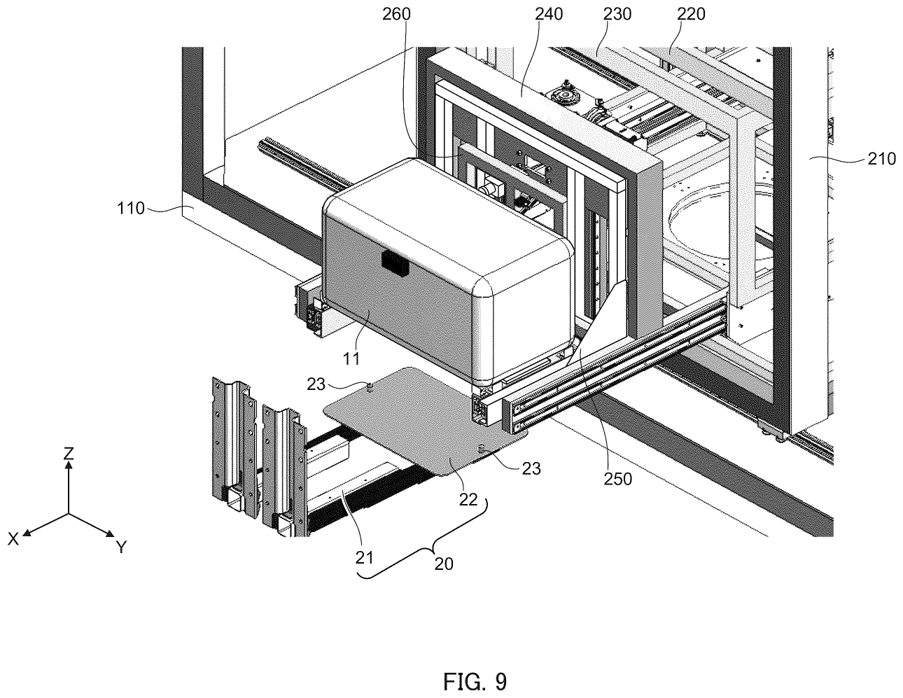

Next, battery replacement apparatus 200 raises second lifting frame 250 as illustrated in FIG. 9. This causes battery 11 to be away from placement table 22 of battery bracket 20.

Battery bracket 20 includes placement table 22 and slide rail 21 that slidably supports placement table 22 in the +X direction. Further, placement table 22 is provided with positioning pins 23. The lower surface of battery 11 is formed with holes (not illustrated) into which positioning pins 23 are fitted, whereby battery 11 is positioned with high accuracy in a state where battery 11 is placed on placement table 22, thereby preventing a terminal from being damaged due to a positional shift of battery 11.

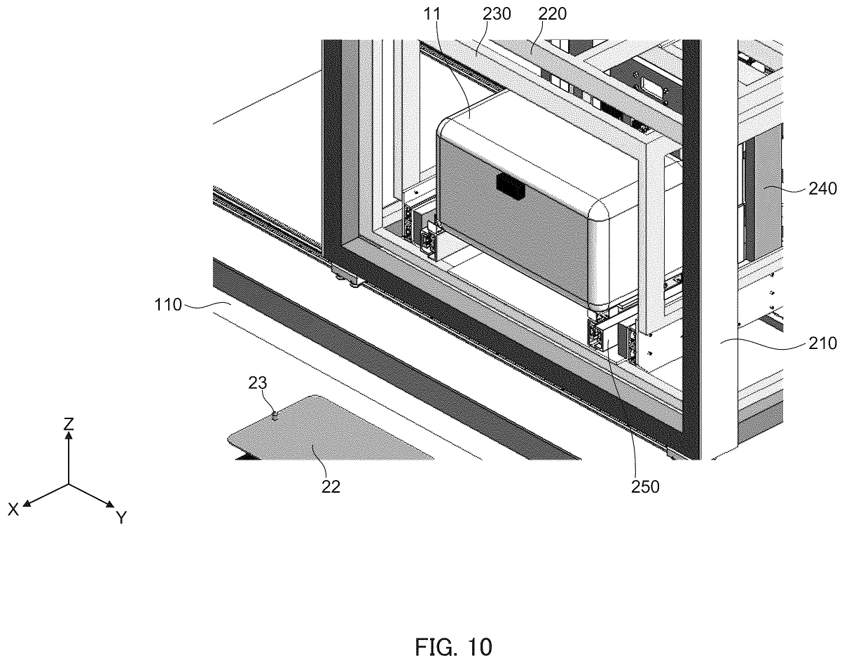

Next, as illustrated in FIG. 10, battery replacement apparatus 200 moves first slide frame 240 to the −X direction until battery 11 is positioned in turning frame 230.

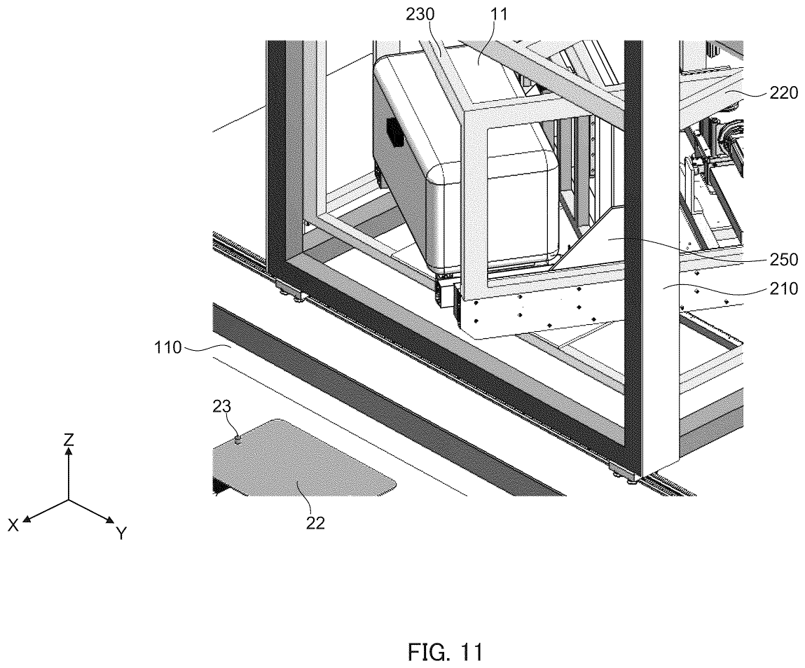

Battery replacement apparatus 200 then turns (rotates) turning frame 230, as illustrated in FIG. 11. Rotating frame 230 by 180° makes battery 11 face housing section 120. Additionally, battery 11 is moved to a desired housing position of housing section 120 by moving traveling frame 210 and first lifting frame 220 simultaneously with the turning operation of turning frame 230. Next, battery 11 is housed in the desired housing position of housing section 120 by moving first slide frame 240, second lifting frame 250, and battery-holding arm 260. Note that the operation of housing battery 11 can be appropriately changed depending on a configuration of housing section 120 and is not particularly limited in the present disclosure.

The operation of taking out battery 11 from vehicle 10 has been described, thus far. In the case of attaching battery 11 to vehicle 10, an operation substantially reverse to the operation at the time of taking-out may be performed.

A brief description will be given below. First, battery replacement apparatus 200 takes out battery 11 that has been charged from housing section 120. Battery replacement apparatus 200 then turns turning frame 230 and moves traveling frame 210 and first lifting frame 220, resulting in a state as illustrated in FIG. 10.

A state of battery replacement apparatus 200 then transitions from the state in FIG. 9 to the state in FIG. 8, and thus, battery 11 is placed on placement table 22. At this time, battery 11 is positioned by positioning pins 23 and locked by locking claws 263.

In this situation, when battery-holding arm 260 is moved in the +X direction, battery 11 is pushed out by pushout portion 260b of battery-holding arm 260; accordingly, the position of battery 11 transitions from the state in FIG. 8 to the state in FIG. 7. In the state in FIG. 7, battery 11 is electrically connected to the vehicle.

### 4. Summary

As described above, the battery replacement system and the battery replacement apparatus of the present disclosure have the following configurations.
1.) A battery replacement system according to one aspect of the present disclosure is battery replacement system 100 for replacing battery 11 mounted on vehicle 10, in which vehicle 10 includes bracket 20 that holds battery 11, and battery replacement apparatus 200 includes an arm (battery-holding arm 260) that holds battery 11 and an arm moving section that moves the arm (battery-holding arm 260), in which the arm moving section includes a first lifting portion (first lifting frame 220) for moving the arm (battery-holding arm 260) at least in a vertical direction within an apparatus main body of battery replacement apparatus 200 and a second lifting portion (second lifting frame 250) for moving the arm (battery-holding arm 260) in a vertical direction outside the apparatus main body.

Thus, it is possible to achieve battery replacement system 100 capable of removing and attaching battery 11 quickly and reliably, by sharing the lifting operation of the arm (battery-holding arm 260) between the first lifting portion (first lifting frame 220) and the second lifting portion (second lifting frame 250).

That is, housing section 120 can be accessed by the first lifting portion (first lifting frame 220), while battery 11 mounted on vehicle 10 can be accessed by the second lifting portion (second lifting frame 250), for example, thereby making it possible to lift battery 11 mounted on vehicle 10 by the second lifting portion (second lifting frame 250) from below to remove and move the battery, without raising the position of vehicle 10 as high as battery replacement apparatus 200. Consequently, for example, as compared to a case where battery 11 is held from above and moved, it is possible to move battery 11 quickly and reliably while preventing the battery from falling off or the like.

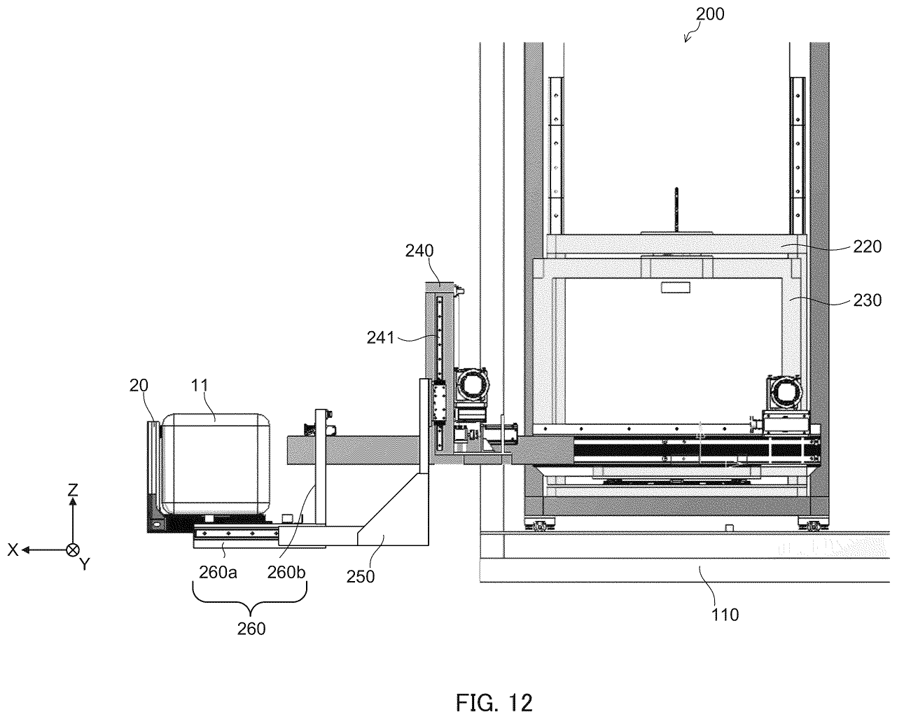

FIG. 12 is a side view of a positional relation in a vertical direction of battery 11 mounted on vehicle 10 and battery replacement apparatus 200. As illustrated in FIG. 12, even when the position of the bottom surface of battery 11 is positioned downward the installation position of battery replacement apparatus 200, battery replacement apparatus 200 of the present embodiment can lower the arm (battery-holding arm 260) below the bottom surface of battery 11 by using the second lifting portion (second lifting frame 250). Consequently, battery 11 can be moved after lifting and removal even when vehicle 10 is on the ground at the same level as battery replacement apparatus 200, for example. This eliminates the need for a device or ramp for jacking up vehicle 10, for example.

Further, performing the lifting operation in two steps reduces the size of arm in a retracted state, thus making it easier to house the first lifting portion and the second lifting portion in the apparatus main body.
2.) In the battery replacement system according to one aspect of the present disclosure, the arm and the arm moving section include: a first slide portion (first slide frame 240) that moves the arm at least in a direction moving towards and away from battery 11 mounted on vehicle 10 (±X direction), in a region including inside the apparatus main body of battery replacement apparatus 200; and a second slide portion (battery-holding arm 260) that moves the arm in the direction moving towards and away from battery 11 mounted on vehicle 10 (±X direction), in a region outside the apparatus main body.

Thus, the sliding operation in the ±X direction is performed in two steps, which reduces the size of the arm in a retracted state, thereby making it easier house the first slide portion and the second slide portion in the apparatus main body.
3.) In the battery replacement system according to one aspect of the present disclosure, the arm includes: placement portion 260a on which battery 11 is placed; and pushout portion 260b that pushes battery 11 toward vehicle 10 (±X direction).
4.) In the battery replacement system according to one aspect of the present disclosure, when battery 11 is taken out from vehicle 10, the arm moving section moves the arm below battery 11 held by bracket 20, places battery 11 on placement portion 260a by raising the arm, and pulls battery 11 into the apparatus main body, and when battery 11 is attached to vehicle 10, the arm moving section moves, outside the apparatus main body, battery 11 that has been taken out from housing section 120 housing battery 11, moves battery 11 onto bracket 20 by lowering the arm, and moves battery 11 to an electrical connection position by pushing battery 11 using pushout portion 260b towards vehicle 10 (+X direction).
5.) In the battery replacement system according to one aspect of the present disclosure, bracket 20 includes: bracket placement portion 22 on which battery 11 is placed; and a support portion (slide rail 21) that slidably supports bracket placement portion 22 between the electrical connection position of battery 11 in vehicle 10 and a battery pull-in position on a side of vehicle 10.

Thus, battery 11 can be positioned at a predetermined battery connection position with high accuracy at the time of attachment of battery 11 that has been replaced. Consequently, it is possible to prevent a terminal from being damaged due to a positional shift of battery 11.
6.) In the battery replacement system according to one aspect of the present disclosure, placement portion 260a of the arm (battery-holding arm 260) is formed with a locking portion (locking claws 263) that locks battery 11.

This makes it possible to prevent battery 11 from falling off or shifting in position from placement portion 260a.
7.) In the battery replacement system according to one aspect of the present disclosure, bracket placement portion 22 of bracket 20 is formed with positioning pin 23 for positioning, to the electrical connection position, battery 11 that has been placed.

This allows battery 11 to be guided to an accurate electrical connection position, thus preventing the terminal from being damaged due to the shift in the electrical connection position.
8.) In the battery replacement system according to one aspect of the present disclosure, battery replacement apparatus 200 is installed in container 110 transportable by a trailer.

This makes it possible to construct battery replacement system 100 simply by transporting and installing container 110 without building a fixed battery replacement station. As a result, capital investment can be greatly reduced.
9.) In the battery replacement system according to one aspect of the present disclosure, container 110 further includes: housing section 120; charging/discharging equipment for charging battery 11 housed in housing section 120; and control unit 130 for controlling battery replacement apparatus 200 and the charging equipment.
10.) A battery replacement apparatus according to one aspect of the present disclosure includes: an arm that holds battery 11 (battery-holding arm 260); and an arm moving section that moves the arm (battery-holding arm 260), in which the arm moving section includes a first lifting portion (first lifting frame 220) for moving the arm (battery-holding arm 260) at least in a vertical direction within an apparatus main body of battery replacement apparatus 200 and a second lifting portion (second lifting frame 250) for moving the arm (battery-holding arm 260) in a vertical direction outside the apparatus main body.
11.) In the battery replacement apparatus according to one aspect of the present disclosure, the arm and the arm moving section include: a first slide portion (first slide frame 240) that moves the arm at least in a direction moving towards and away from battery 11 mounted on vehicle 10 (+X direction), in a region including inside the apparatus main body of battery replacement apparatus 200; and a second slide portion (battery-holding arm 260) that moves the arm in the direction moving towards and away from battery 11 mounted on vehicle 10 (+X direction), in a region outside the apparatus main body.
12.) In the battery replacement apparatus according to one aspect of the present disclosure, the arm includes: placement portion 260a on which battery 11 is placed; and pushout portion 260b that pushes battery 11 toward vehicle 10 (+X direction).
13.) In the battery replacement apparatus according to one aspect of the present disclosure, placement portion 260a of the arm (battery-holding arm 260) is formed with a locking portion (locking claws 263) that locks battery 11.
14.) The battery replacement apparatus according to one aspect of the present disclosure is installed in container 110 transportable by a trailer.
15.) A battery replacement system according to one aspect of the present disclosure includes a plurality of battery replacement apparatuses 200 described above, in which, in a case where replacement of a battery of the same vehicle is performed, a taking-out operation of battery 11 from battery housing section 120 is performed by second battery replacement apparatus 200, while a taking-out operation of battery 11 from vehicle 10 is performed by an arm of first battery replacement apparatus 200.

In the manner described above, it is possible to achieve a battery replacement system capable of replacing battery 11 more quickly.

The embodiment described above is merely an example of specific implementation of the present invention, and the technical scope of the present invention should not be restrictively interpreted by this embodiment. That is, the present invention may be implemented in various forms without departing from the spirit thereof or the major features thereof.

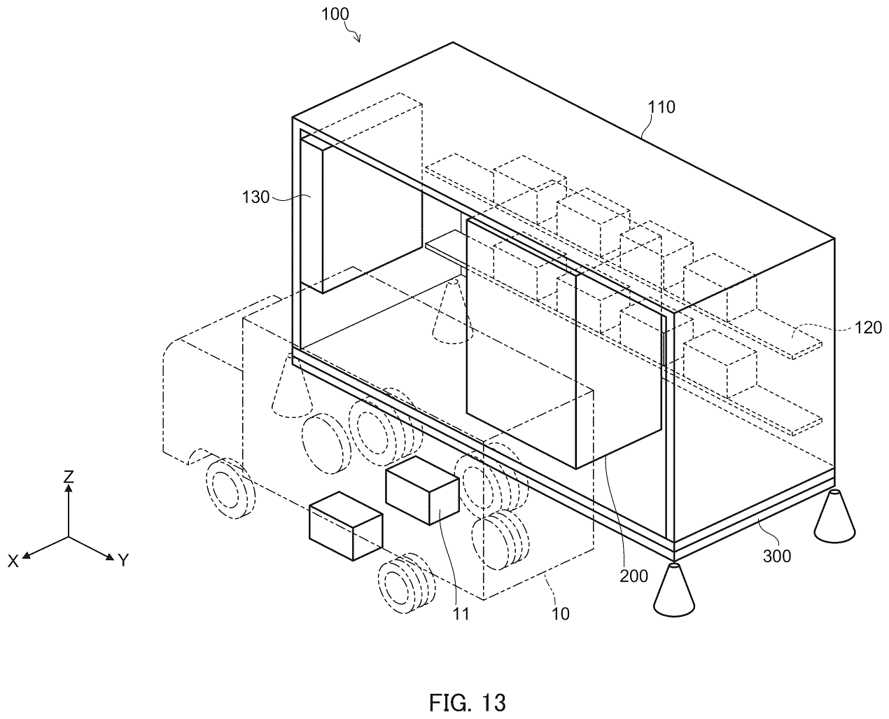

In the above-described embodiment, as illustrated in FIG. 1, a case has been described where battery replacement apparatus 200 is used in a condition in which container 110 is lowered from a cargo bed of a trailer to the ground with a crane or the like; however, battery replacement apparatus 200 may be used while container 110 remains loaded on cargo bed 300 of the trailer, as illustrated in FIG. 13, in which elements corresponding to those in FIG. 1 are given the same reference numerals. In this manner, the battery replacement can be performed more easily.

In addition to the above described embodiment, container 110 may be provided with a solar panel (not illustrated), and battery 11 in housing section 120 may be charged by electricity generated by the solar panel. Container 110 may be extended in a longitudinal direction (+Y direction) in accordance with the storage number of batteries 11, for example. Further, container 110 may have a function of discharging to the outside.

### INDUSTRIAL APPLICABILITY

The present disclosure is widely applicable for a battery replacement system and a battery replacement apparatus each of which replaces a battery mounted on a vehicle without manual labor.

### REFERENCE SIGNS LIST

10 Vehicle
11 Battery
20 Bracket
100 Battery replacement system
110 Container
120 Housing section
130 Control unit
200 Battery replacement apparatus
210 Traveling frame
211 Traveling rail
212, 222, 232, 242 Actuator
220 First lifting frame
221 Lifting rail
230 Turning frame
240 First slide frame
250 Second lifting frame
260 Battery-holding arm (second slide frame)
260a Placement portion
260b Pushout portion
261 Slide rail
271 Battery-position detecting camera
272 Battery-detection limit switch
300 Cargo bed

1. A battery replacement system for replacing a battery mounted on a vehicle, the battery replacement system comprising:
a bracket that is installed on the vehicle and holds the battery; and
a battery replacement apparatus,
wherein the battery replacement apparatus includes:
an arm that holds the battery; and
an arm moving section that moves the arm, and
wherein the arm moving section includes:
a first lifting portion for moving the arm at least in a vertical direction within an apparatus main body of the battery replacement apparatus; and
a second lifting portion for moving the arm in a vertical direction outside the apparatus main body of the battery replacement apparatus.

2. The battery replacement system according to claim 1, wherein the arm and the arm moving section include:
a first slide portion that moves the arm at least in a direction moving towards and away from the battery mounted on the vehicle, in a region including inside the apparatus main body of the battery replacement apparatus; and
a second slide portion that moves the arm in the direction moving towards and away from the battery mounted on the vehicle, in a region outside the apparatus main body.

3. The battery replacement system according to claim 1, wherein the arm includes:
a placement portion on which the battery is placed; and
a pushout portion that pushes the battery toward the vehicle.

4. The battery replacement system according to claim 3, wherein,
when the battery is taken out from the vehicle, the arm moving section moves the arm below the battery held by the bracket, places the battery on the placement portion by raising the arm, and pulls the battery into the apparatus main body, and
when the battery is attached to the vehicle, the arm moving section moves, outside the apparatus main body, the battery that has been taken out from the housing section housing the battery, moves the battery onto the bracket by lowering the arm, and moves the battery to an electrical connection position by pushing the battery using the pushout portion towards the vehicle.

5. The battery replacement system according to claim 1, wherein the bracket includes:
a bracket placement portion on which the battery is placed; and
a support portion that slidably supports the bracket placement portion between an electrical connection position of the battery in the vehicle and a battery pull-in position on a side of the vehicle.

6. The battery replacement system according to claim 3, wherein the placement portion of the arm is formed with a locking portion that locks the battery.

7. The battery replacement system according to claim 5, wherein the bracket placement portion of the bracket is formed with a positioning pin for positioning, to the electrical connection position, the battery that has been placed.

8. The battery replacement system according to claim 1, wherein the battery replacement apparatus is installed in a container transportable by a trailer.

9. The battery replacement system according to claim 4, wherein:
the battery replacement apparatus is installed in a container transportable by a trailer, and
the container further includes: a housing section; charging equipment for charging the battery housed in the housing section; and a control unit for controlling the battery replacement apparatus and the charging equipment.

10. A battery replacement apparatus for replacing a battery mounted on a vehicle, the battery replacement apparatus comprising:
an arm that holds the battery; and
an arm moving section that moves the arm,
wherein the arm moving section includes:
a first lifting portion for moving the arm at least in a vertical direction within an apparatus main body of the battery replacement apparatus; and
a second lifting portion for moving the arm in a vertical direction outside the apparatus main body.

11. The battery replacement apparatus according to claim 10, wherein the arm and the arm moving section further include:
a first slide portion that moves the arm at least in a direction moving towards and away from the battery mounted on the vehicle, in a region including inside the apparatus main body of the battery replacement apparatus; and
a second slide portion that moves the arm in the direction moving towards and away from the battery mounted on the vehicle, in a region outside the apparatus main body.

12. The battery replacement apparatus according to claim 10, wherein the arm includes:
a placement portion on which the battery is placed; and
a pushout portion that pushes the battery toward the vehicle.

13. The battery replacement apparatus according to claim 12, wherein the placement portion of the arm is formed with a locking portion that locks the battery.

14. The battery replacement apparatus according to claim 10, wherein the battery replacement apparatus is installed in a container transportable by a trailer.

15. A battery replacement system comprising a plurality of the battery replacement apparatuses according to claim 10, wherein,
in a case where replacement of a battery of the same vehicle is performed, a taking-out operation of the battery from a battery housing section is performed by an arm of a certain battery replacement apparatus, while a taking-out operation of the battery from the vehicle is performed by an arm of a first battery replacement apparatus, the certain battery replacement apparatus being referred to as a second battery replacement apparatus.
